(19) United States
(12) Patent Application Publication
(10) Pub. No.: US 2010/0293075 A1
(43) Pub. Date: Nov. 18, 2010

(54) METHOD FOR MANUFACTURING SHOES BY USING AN INTERACTIVE SYSTEM

(75) Inventors: Chuang Chuan CHEN, Taipei County (TW); Ming-Te Chen, Taichung Hsien (TW)

Correspondence Address: Kan Kuan Chuan, P.O. Box 77-13, Taipei, 11161, TW

(73) Assignee: Ming Te Chen, Taichung Hsien (TW)

(21) Appl. No.: 12/792,745

(22) Filed: Jun. 3, 2010

Related U.S. Application Data
(63) Continuation-in-part of application No. 12/515,047, filed on May 15, 2009.

(51) Int. Cl. G06Q 30/00; G06Q 90/00; G06Q 50/00; G06F 19/00

(52) U.S. Cl. 705/27; 705/500; 700/109; 700/197; 700/136

(57) ABSTRACT

A method for obtaining shoes includes a step for obtaining shoe information; a step for communication with manufacturers; a step for manufacturing the shoes; a step for delivery and/or try-on; a step for amendment, and a step for finish manufacture. The method allows the customers to design their shoes by themselves and communicate with the shoe manufactures so as to obtain desired shoes.

This is a Continuation-In-Part application for applicant's former application with the application Ser. No. 12/515,047, filed on May 15, 2009.

### BACKGROUND OF THE INVENTION

The conventional way for buying shoes generally is to visit a shoe store and select the preferred ones from the demonstrated shoes on the racks. Customers passively accept what the shoe design companies provide for the market. There is no interaction between the customer and shoe design companies.

For some customers who do not have time to visit the shoe stores or for some customers who are not convenient to go shopping, the conventional way for buying shoes cannot meet their needs.

The present invention intends to provide a method which allows the customers to design the shoes and communicate with the shoe makers so as to have preferable shoes.

### SUMMARY OF THE INVENTION

The present invention relates to a method for obtaining shoes and the method comprises a step for obtaining shoe information; a step for communication with manufacturers; a step for manufacturing the shoes; a step for delivery and/or try-on; a step for amendment, and a step for finish manufacture. The method allows the customers to design their shoes by themselves and communicate with the shoe manufactures so as to obtain desired shoes.

The primary object of the present invention is to provide a site to combine the designing, manufacturing, and selling shoes.

Another object of the present invention is to attract customers to buy shoes by showing the customers the manufacturing processes.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 shows the first embodiment of the method of the present invention;

FIG. 2 shows the second embodiment of the method of the present invention, and

FIG. 3 shows the steps in the manufacturing steps of the method of the present invention.

### DETAILED DESCRIPTION OF THE PREFERRED EMBODIMENT

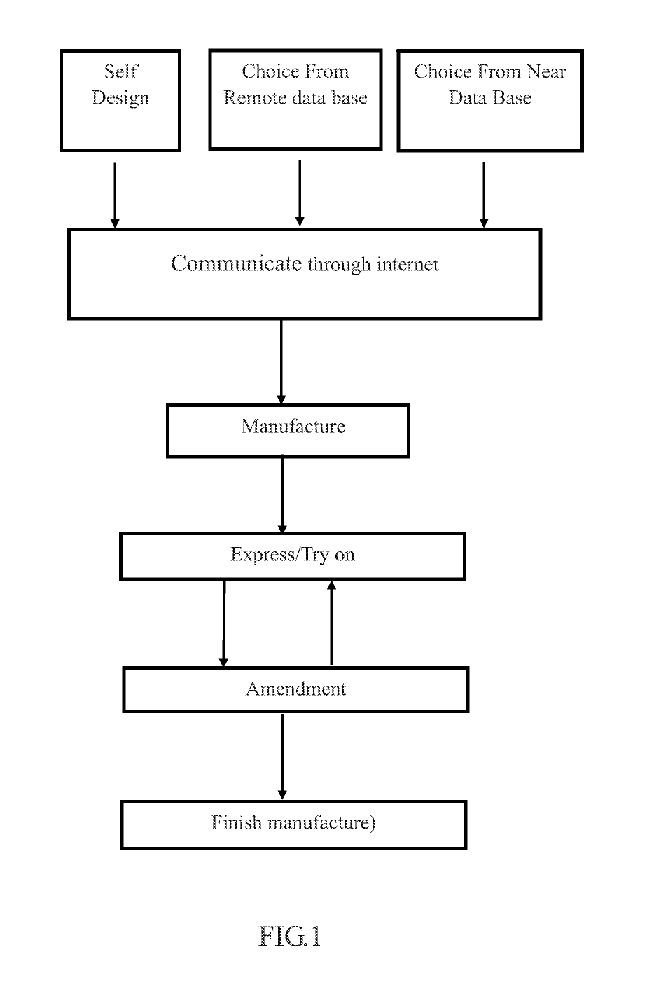

Referring to FIG. 1, the method of the present invention comprises

step 1: obtaining shoe information;

step 2: communication with manufacturers;

step 3: manufacturing the shoes;

step 4: delivery and/or try-on:

step 5: amendment, and

step 6: finish manufacture.

There are three ways to obtain the shoes information in step 1 and the three ways can be that the customers design the shoes by themselves, the customers have the design information from remote data bases by using their own computers, or that customers have the design information from near data bases. In other words, the shoes information can be obtained by the customers by any different ways that are possible, such as from the internet, from the magazines or even from the customers' own ideas.

The customers can conduct a telephone interview with the shoe manufacturers, or send a video to communicate with the shoe manufacturers, or conduct the communication with the shoe manufacturers via internet. The step ensures that the customers' needs and intentions are clearly sent to the shoes manufacturers. The customers do not need to personally attend the shoes manufacturers' place and this is convenient for some customers.

The information is then sent to the manufacturer's plant to proceed the manufacturing processes. After the shoes are finished, the customers are acknowledged and try the shoes on at the nearby stores. If the customers have any further ideas or flaws are found of the shoes, the shoes then sent to be amended. The try-on and amendment can be repeated until the shoes are accepted by the customers, the customers then pay for the cost.

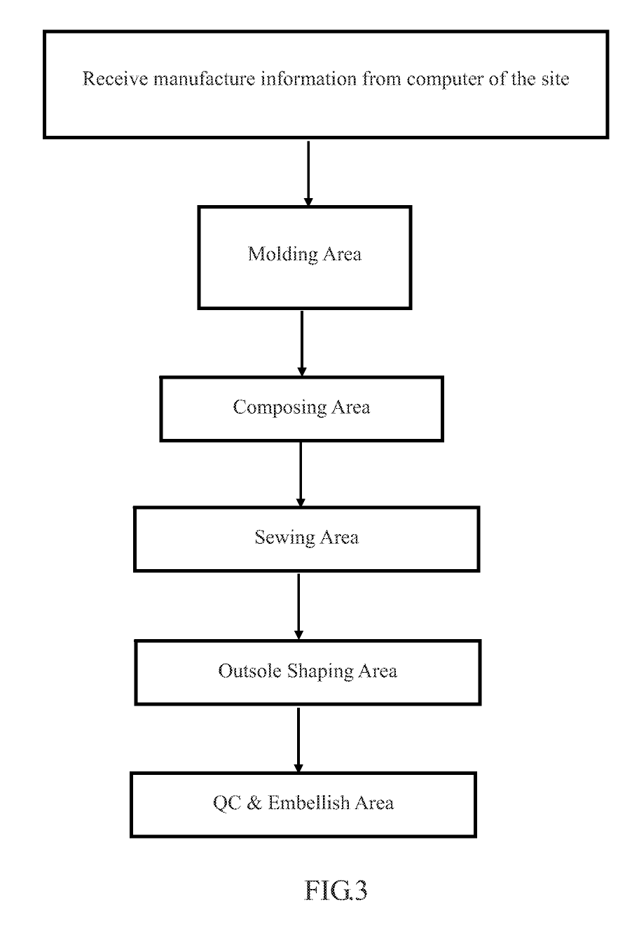

In the step 3, as shown in FIG. 3, it comprises a sub-step of receiving manufacture information from computer of the site which can be the internet or the deign ideas form the customers. The manufacture information is then sent to a molding area to make a photo-type which is then sent to a composing area to compose at high pressure to form different parts of the shoes. The parts are then sent to a sewing area to sew the parts together. The sewed parts are sent to outsole shaping area to be connected with the outsole to form a shoe. At the final process, the shoe is sent to quality-control and embellish area to finish the shoe.

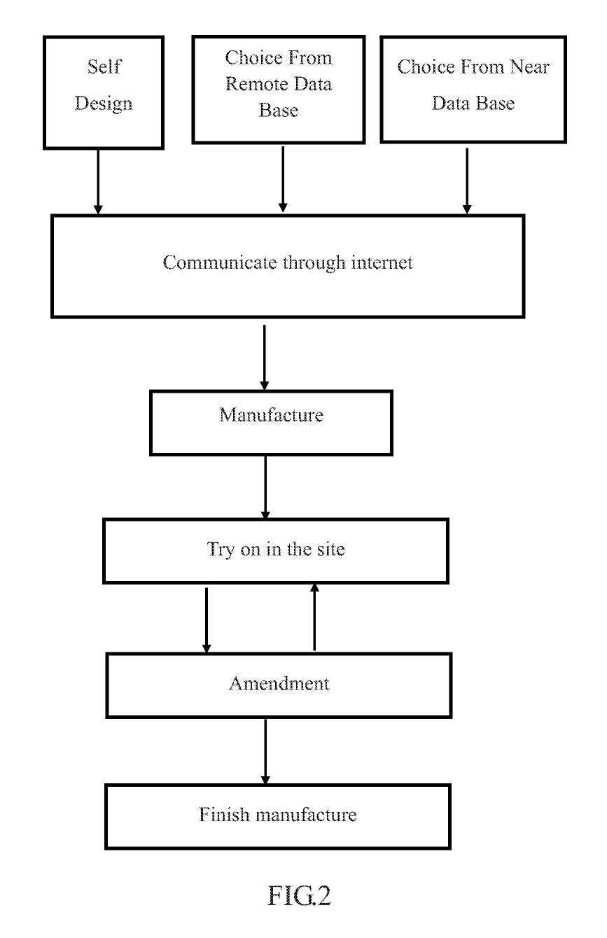

FIG. 2 shows the second embodiment of the present invention, wherein there is a slightly difference in step 2 of the first embodiment, wherein the customers can communicate with the shoes manufacturers at the manufacturers' place which can be a building or any spacious place including exhibiting areas, manufacturing areas, amending areas, fitting areas, and cashier areas. A network is also provided at the site. The network includes some platforms for customers to select their preferred shoe models. The platforms may include monitors with input devices (keyboards, mouse, or just touch screen monitors), scanners, and interphones, or standard PCs, depending on the demands. The network also includes a memory to provide a database storing the selections about materials, colors, patterns, and sizes.

The other difference between the second embodiment from the first embodiment is that, in the first embodiment, the customers try the shoes on at the nearby stores, but in the second embodiment, the shoes are delivered to the customers' places and the customers try the shoes at their houses.

According to the present invention, the customers either attend the shoes manufacturers' stores to get the shoes information and send the information to the manufacturers, or the customers obtain the information of the shoes and send the information via internet or other ways such as mailing the information to the manufacturers.

The customers also discuss the information of the shoes with the shoes manufacturers by various ways to ensure that the needs of the customers are acknowledged by the shoes manufacturers. This is particularly important in the present invention because, in the conventional way to purchase shoes, the customers cannot share their ideas or intentions with the shoes manufactures before the shoes are made. By the method of the present invention, the shoes manufacturers receive the customers' ideas or intentions before the shoes are made and this reduces manufacturers cost because the shoes they made are exactly what the customers want.

This is the perfect way that links the customers directly to the shoes manufacturers, the shoes manufacturers do not need to predict the trends what the customers need, and the customers can control the materials, the colors, the patterns, the sizes and the styles they need.

While we have shown and described the embodiment in accordance with the present invention, it should be clear to those skilled in the art that further embodiments may be made without departing from the scope of the present invention.

What is claimed is:

1. A method for obtaining shoes, comprising:
step 1: obtaining shoe information;
step 2: communication with manufacturers;
step 3: manufacturing the shoes;
step 4: delivery and/or try-on:
step 5: amendment, and
step 6: finish manufacture.

2. The method as claimed in claim 1, wherein the step 1 comprises customers design the shoes by themselves.

3. The method as claimed in claim 1, wherein the step 1 comprises customers have the design information from remote data bases.

4. The method as claimed in claim 1, wherein the step 1 comprises customers have the design information from near data bases.

5. The method as claimed in claim 1, wherein the step 2 comprises telephone interview with the shoe manufacturers.

6. The method as claimed in claim 1, wherein the step 2 comprises video interview with the shoe manufacturers.

7. The method as claimed in claim 1, wherein the step 2 comprises communication with the shoe manufacturers via internet.

8. The method as claimed in claim 1, wherein the step 3 comprises a sub-step of receiving manufacture information from computer of the site, the manufacture information is sent to a molding area to make a photo-type, the photo-type is sent to a composing area to compose at high pressure to form different parts, the parts are sent to a sewing area to sew the parts together, the sewed parts are sent to outsole shaping area to be connected with the outsole to form a shoe, and the shoe is sent to quality-control and embellish area to finish the shoe.
